(19) United States
(12) Patent Application Publication
(10) Pub. No.: US 2023/0252304 A1
(43) Pub. Date: Aug. 10, 2023

(54) METHOD AND SYSTEM FOR KNOWLEDGE DISTILLATION TECHNIQUE IN MULTIPLE CLASS COLLABORATIVE FILTERING ENVIRONMENT

(71) Applicant: IUCF-HYU (INDUSTRY-UNIVERSITY COOPERATION FOUNDATION HANYANG UNIVERSITY), Seoul (KR)

(72) Inventors: Sang-Wook Kim, Seoul (KR); Hong-Kyun Bae, Seoul (KR); Jiyeon Kim, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 17/979,487

(22) Filed: Nov. 2, 2022

(30) Foreign Application Priority Data
Feb. 4, 2022 (KR) 10-2022-0014638
Jun. 20, 2022 (KR) 10-2022-0074989

(51) Int. Cl. G06N 3/096; G06N 3/045

(52) U.S. Cl. CPC G06N 3/096; G06N 3/045

(57) ABSTRACT

A recommendation method performed by a recommendation system in a multiple-class collaborative filtering environment includes learning pre-use preference and post-use preference by a plurality of teachers; selecting items to be transferred to a student model by predicting pre-use preference for items unobserved by a user based on the learned pre-use preference; determining a soft label based on post-use preference, which is predicted for the selected items based on the learned post-use preference; and transferring the determined soft label to the student model as distilled knowledge, and recommending, by the student model, items having high pre-use preference and high post-use preference based on the received distilled knowledge.

### CROSS-REFERENCE TO RELATED APPLICATIONS

This application is based on and claims priority under 35 U.S.C. § 119 to Korean Patent Application Nos. 10-2022-0014638, filed on Feb. 4, 2022 and 10-2022-0074989, filed on Jun. 20, 2022 in the Korean Intellectual Property Office, the disclosures of which are incorporated by reference herein in their entireties.

### BACKGROUND

### 1. Field

Example embodiments of the disclosure relate to a recommendation technique using a knowledge distillation technique in a multiple-class environment.

### 2. Description of the Related Art

Recently, the number of users and items in a recommendation system has rapidly been increasing. To effectively capture nonlinear and complex patterns between the users and items, the sizes of neural models used in collaborative filtering is increasing. A large-sized model having a large number of parameters is capable of providing a recommendation result with a higher accuracy by using high capacity. However, these models may cause great delays in the stage of deducting recommendation results, which may be a factor to lower the availability and practicality of these models.

The knowledge distillation technique is one of the model compression techniques for reducing a model size. Complex and large-sized models are referred to as teacher models, and simple and small-sized models are referred to as student models. A student model is learned by using distilled knowledge from a pre-learned teacher model. The student model having learned in this manner may achieve two objectives: a shorter result deduction time than a teacher model and a higher accuracy than small-sized models without the knowledge distillation technique applied thereto. Accordingly, the knowledge distillation technique is under active study in various fields, such as natural language processing and a recommendation system.

Collaborative filtering may be used in both a single-class environment and a multiple-class environment. Studies related to knowledge distillation techniques in the related art for collaborative filtering have been proposed with a main focus on single-class environments, but for effective collaborative filtering performance, consideration of multiple-class environments as well as single-class environments is still important.

In addition, multiple-class feedback reflects pre-use preference and post-use preference of a user for an item. Pre-preference may be inferred from an external characteristic of the item, and the post-use preference may be inferred from an internal characteristic of the item. Methods related to the knowledge distillation techniques for collaborative filtering in the related art are also applicable in the multiple-class environments. The techniques distill knowledge for the student model by using only one teacher model from the feedback (e.g., rating score) left on the item by the user. However, in this case, there is a limitation that post-use preference in multiple-class feedback may be transferred as knowledge to the student model, but pre-use preference may not be transferred thereto. Thus, in the multiple-class environment, it may be difficult to make a recommendation with a high accuracy (that is, a recommendation of an item having both high pre-use preference and high post-use preference) by using the student model having learned in this manner.

### PRIOR ART DOCUMENT

### Patent Literature

KR 10-2015-0101284

### SUMMARY

Provided are a method and a system for item recommendation based on a knowledge distillation technique in a multiple-class environment by using a structure of a plurality of teacher models.

Provided are a method and a system for learning pre-use preference and post-use preference for an item of a user in a plurality of teacher models by using a knowledge distillation technique, transferring an output of the learning to a student model, and recommending an item having high pre-use preference and high post-use preference by learning in the student model.

Additional aspects will be set forth in part in the description which follows and, in part, will be apparent from the description, or may be learned by practice of the presented embodiments of the disclosure.

According to an aspect of an example embodiment, provided is a recommendation method, performed by a recommendation system including at least one processor in a multiple-class collaborative filtering environment, the recommendation method including: transferring to a student model, by a knowledge transfer unit implemented by at the at least one processor, knowledge information about an item deduced by using collaboration of a plurality of teacher models; and recommending, by an item recommendation unit implemented by the at least one processor, an item having a high pre-use preference and a high post-use preference of a user by using the student model, which has performed learning by using the transferred knowledge information, wherein a recommendation model used by the recommendation system includes the plurality of teacher models and the student model and is configured to recommend the item based on a knowledge distillation technique.

The transferring may include transferring, to the student model, an item having a high pre-use preference and an item a having low pre-use preference, predicted by a teacher model among the plurality of teacher models included in the recommendation model, among items unobserved by the user.

A first teacher model among the plurality of teacher models may have learned a pre-use preference of the user for an item.

A first teacher model, among the plurality of teacher models, may be configured to select a first item based on a high pre-use preference predicted by the first teacher model and a second item based on a low pre-use preference predicted by the first teacher model, and the transferring may include transferring, to the student model, a post-use preference predicted by a second teacher model for the first item, and a post-use preference predicted by the second teacher model for the second item.

The transferring may include determining a soft label for the first item as a post-use preference predicted by the second teacher model, and determining a soft label for the second item as a rating score equal to or less than a preset reference.

The second teacher model may have learned a post-use preference of a user for the item.

The second teacher model may predict a post-use preference by using a rating score assigned to the item after the item is used.

The recommending of the item may include, in the student model, learning a pre-use preference and a post-use preference for an item transferred as knowledge information by using collaboration of a plurality of teacher models included in the recommendation model.

The recommending of the item may include recommending an item equal to or greater than a preset reference for each user by using the learned student model.

According to an aspect of an example embodiment, provided is a non-transitory computer-readable medium storing program executable by at least one processor to perform the recommendation method in a multiple-class collaborative filtering environment.

According to an aspect of an example embodiment, provided is a recommendation system including at least one processor to implement: a knowledge transfer unit configured to transfer, to a student model, knowledge information related with an item deduced by using collaboration of a plurality of teacher models; and an item recommendation unit configured to recommend an item having a high pre-use preference and a high post-use preference of a user by using the student model having learned by using the transferred knowledge information, wherein a recommendation model comprises the plurality of teacher models and the student model and is configured to recommend an item based on a knowledge distillation technique.

The knowledge transfer unit may be further configured to transfer, to the student model, an item having a high pre-use preference and an item having a low pre-use preference predicted by a teacher model among the plurality of teacher models included in the recommendation model among items unevaluated by the user, and the teacher model may have learned a pre-use preference of the user for the item.

A first teacher model may be configured to select a first item based on a high pre-use preference predicted by the first teacher model and a second item based on a low pre-use preference predicted by the first teacher model, and the knowledge transfer unit may be further configured to transfer, to the student model, a post-use preference for the first item, predicted by a second teacher model, and a post-use preference for the second item, predicted by the second teacher model.

The item recommendation unit may be further configured to learn, by using the student model, a pre-use preference and a post-use preference for the item transferred as the knowledge information by using the collaboration of the plurality of teacher models, and recommend an item equal to or greater than a preset reference for each user by using the learned student model.

According to an aspect of an example embodiment, provided is a recommendation method, performed by a recommendation system including a knowledge transfer unit and item recommendation unit, implemented by at least one processor, in a multiple-class collaborative filtering environment. The knowledge transfer unit includes a first teacher and a second teacher and the recommendation method includes: learning, by the first teacher, a pre-use preference among pieces of multiple-class feedback received from a user, and learning, by the second teacher, a post-use preference among the pieces of multiple-class feedback; predicting, by the first teacher, a pre-use preference for items unobserved by the user based on the learned pre-use preference, and selecting items to be transferred to a student model based on the predicted pre-use preference; determining, by the second teacher, a soft label based on a post-use preference, which is predicted for items selected by the first teacher based on the learned post-use preference, and transferring the determined soft label as distilled knowledge to the student model; and performing, by the student model, learning based on the received distilled knowledge, and recommending items having a high pre-use preference and a high post-use preference by using the item recommendation unit.

The knowledge transfer unit may be configured to train the first teacher by generating a pre-use preference matrix based on items having a record of being evaluated by the user, and train the second teacher by generating a post-use preference matrix based on a rating score actually evaluated by the user for the items having the record of being evaluated by the user.

The student model may be configured to receive the distilled knowledge that is distilled twice by using collaboration of the first teacher and the second teacher.

The knowledge transfer unit may be configured to: use, as the soft label, the post-use preference predicted by the second teacher only for an item having a high pre-use preference among the items, selected by the first teacher among the items unobserved by the user, and determine a rating score equal to or less than a preset reference for an item having a low pre-use preference among the items selected by the first teacher as the soft label, and transfers the soft label to the student model as the distilled knowledge.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram of a recommendation operation based on a knowledge distillation technique in a multiple-class collaborative filtering environment in a recommendation system, according to an embodiment;

FIG. 2 is a diagram illustrating an example of pre-use preference and post-use preference for an item, according to an embodiment;

FIG. 3 is a diagram illustrating a matching rate between a set of top ten items based on predicted pre-use preference and post-use preference, according to an embodiment;

FIG. 4 is a block diagram of a configuration of a recommendation system, according to an embodiment;

FIG. 5 is a flowchart of a recommendation method in a multiple-class collaborative filtering environment in a recommendation system, according to an embodiment;

FIG. 6 is a diagram illustrating an example of a knowledge distillation-based recommendation algorithm, according to an embodiment; and

FIG. 7 is a flowchart illustrating an example of a recommendation method in a multiple-class collaborative filtering environment performed by a recommendation system, according to another embodiment of the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, descriptions will be given in detail with reference to the drawings accompanying embodiments.

The knowledge distillation technique may be one of the model compression techniques used to reduce an inference time while maintaining an accuracy of deep learning models. General studies related to knowledge distillation techniques for collaborative filtering of recommendation systems have mainly considered only single-class environments. Accordingly, when these studies are used in a multiple-class environment, there may be an issue that effective performance and a recommendation accuracy cannot be obtained. To solve this issue, in an embodiment, a recommended operation based on the knowledge distillation technique, that may be effectively used in the multiple-class environment, is described considering the characteristics of the multiple-class environment.

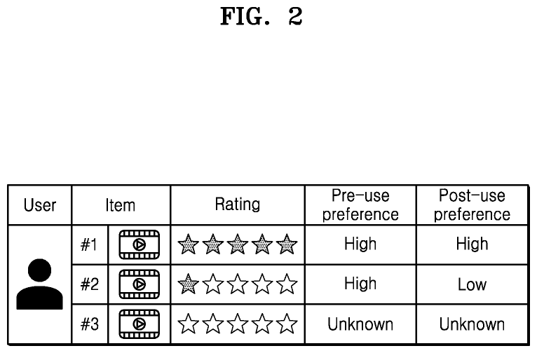

The knowledge distillation technique may be a model-independent framework designed to transfer knowledge deduced from a complex large-sized model (that is, a teacher model) to a small model (that is, a student model). The entire process of the knowledge distillation technique may include operations below. The teacher model may be trained by using observed user feedback (that is, a hard label). As illustrated in an example of FIG. 2, the user feedback may be a rating score directly evaluated by the user after watching a movie. The score directly evaluated by the user may be used as a hard label. Prediction for missing feedback of the teacher model (that is, a soft label) may be transferred to the student model as distilled knowledge. The student model may learn by using the hard label and the soft label. Lastly, the student model may have a faster inference time and improved accuracy than the teacher model. An objective function of the student model may be formulated as follows.

[symbol]

=(1−α) [symbol] _{CF}+α [symbol] _{KD} Equation 1:

In this case, [symbol] _{CF} may represent a loss function for the hard label having a collaborative filtering (CF) model adopted as the student model. [symbol] _{CKD} may represent a loss function for knowledge transferred by the teacher model (that is, the soft label). α may represent a hyper-parameter for balancing two losses.

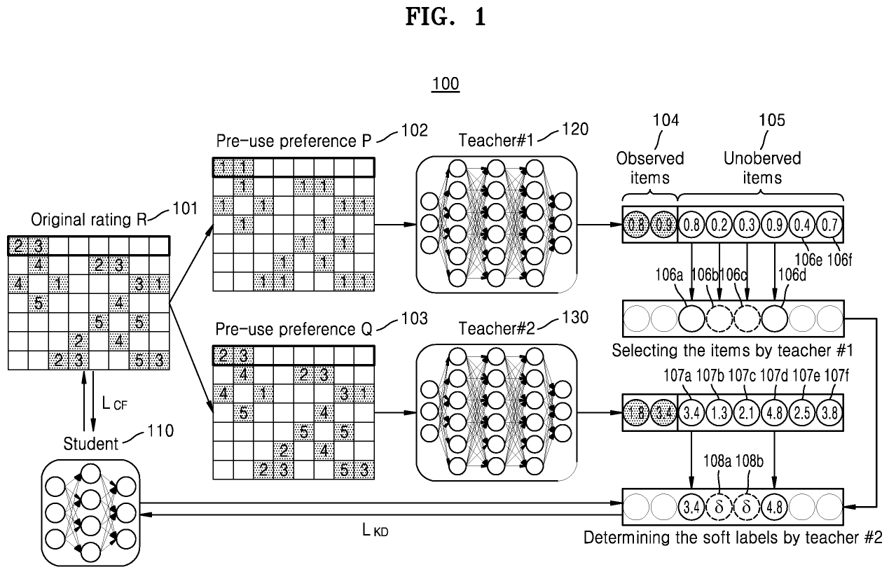

FIG. 1 is a diagram of a recommendation operation by using a recommendation model in a recommendation system 100, according to an embodiment.

The recommendation system 100 may recommend an item, which a user tends to prefer, based on feedback left by the user on the item by using the recommendation model. In an embodiment, the recommendation system 100 may use a recommendation model including a plurality of teacher models 120 and 130 and a student model 110.

The plurality of teacher models 120 and 130 may learn preferences of different types from multiple-class feedback 101 of a user. For example, in FIG. 1, the teacher #1 120 may learn by using a pre-use preference matrix P 102 among the multiple-class feedback 101, and the teacher #2 130 may learn by using a post-use preference matrix Q 103 of a user among the multiple-class feedback 101.

Pre-use preference may mean preference, which a user has for an item before using the item, and may be related to external characteristics (or objective characteristics) of the item. Post-use preference may mean preference, which a user has for an item after using the item, and may be related to internal characteristics (or subjective characteristics) of the item.

A movie is described as an example of the item. In this case, the external characteristics of the item may include a director, an actor, genre, or the like, which are preferred by the user. In addition, the internal characteristics of the item may include a rating score evaluated by the user after watching the movie. Referring to FIG. 2, the user may assign scores of 1 to 5 stars to a movie the user has watched. Alternatively, points of 1 to 5 may be assigned. A higher score may mean higher satisfaction of the user with the movie.

In FIG. 1, as an example of multiple-class feedback of a user, a matrix R 101, in which the user evaluates an item, is shown. In the matrix R 101, empty spaces may indicate items, that have never been used by the user or have not been evaluated by the user. For example, the user may assign rating scores of two points to an item (1,1) and three points to an item (1,2) on a first row of the matrix R 101. In addition, an empty may be assigned to items (1,3) through (1,8), which means items have never been used or evaluated by the user.

In the matrix R 101, the recommendation system 100 may generate the pre-use preference matrix P 102 including items assigned with a value of 1, which indicates the items have a record of being evaluated by the user, and generate a post-use preference matrix Q 103 including items assigned with the rating scores, which have a record of being evaluated by the user. For example, when the user assigns two points to the item (1,1) on the first row of the matrix R 101, the item (1,1) may be determined as an item having a record evaluated by the user, and ‘1’ may be assigned to the item (1,1) of the pre-use preference matrix P 102. In addition, ‘2’, which is a score (that is, two points) actually assigned by the user, may be assigned to the item (1,1) of the post-use preference matrix Q 103.

The teacher #1 120 may learn by using the pre-use preference matrix P 102 and output first distilled knowledge based the learning. An example of the first distilled knowledge may include pre-use preferences 106a through 106f predicted for an item 105, which has not been used by the user. The teacher #2 130 may learn by using the post-use preference matrix Q 103, and output second distilled knowledge. The second distilled knowledge may include post-use preferences 107a through 107f predicted for unobserved items 105, which the user has never used.

The teacher #1 120 may select items 106a, 106b, 106c, and 106d to be transferred to the student model 110, based on pre-use preference values predicted for the unobserved items 105, which the user has never used. In an embodiment, the teacher #1 120 may select the items 106a and 106d as items of interest to the user and the items 106b and 106c as items of no interest to the user, among the unobserved items 105, and may transfer the items 106a through 106d to the student model 110. The teacher #1 120 may select the items 106a, 106b, 106c, and 106d to be transferred to the student model 110 by using θⁱⁿ and θ^{un}, based on the pre-use preference values predicted for the unobserved items 105, which the user has never used. θⁱⁿ may represent a value of a ratio for determining an item of interest based on the pre-use preference predicted by the teacher #1 120, among the unobserved items 105, which the user has never used. θ^{un} may represent a value of a ratio for determining an item of no interest based on pre-use preference predicted by the teacher #1 120, among the unobserved items 105, which the user has never used. Optimized values of θⁱⁿ and θ^{un} may be determined empirically, or may be determined as a preset value.

In FIG. 1, when each of the θⁱⁿ and the θ^{un} is 33, only the items 106a and 106d at the top about 33% based on the predicted pre-use preference of the teacher #1 120 may be considered as the items of interest. In addition, only the items 106b and 106c at the lower about 33% based on the predicted post-use preference of the teacher #1 120 may be considered as the items of no interest.

The student model 110 may learn knowledge on pre-use preference of the unobserved items 105, which the user has never used, based on information about the items 106a, 106b, 106c, and 106d selected by the teacher #1 120. Among the items 106a, 106b, 106c, and 106d selected by the teacher #1 120, the student model 110 may learn the items 106a and 106d of interest to the user and the items 106b and 106c of no interest to the user.

The teacher #2 130 may use, as soft labels, the post-use preference values predicted for the items 106a, 106b, 106c, and 106d selected by the teacher #1 120 among the unobserved items 105. In other words, the teacher #2 130 may use, as the soft labels, the post-use preference values predicted for the items 106a, 106b, 106c, and 106d selected by the teacher #1 120, which are respectively about 3.4 (107a), about 1.3 (107b), about 2.1 (170c), and about 4.8 (107d).

However, in another embodiment, the teacher #2 130 may use, as the soft labels, only the post-use preference values predicted for the items 106a and 106d, of interest to the user, among the items 106a, 106b, 106c, and 106d selected by the teacher #1 120, which are respectively about 3.4 (107a) and about 4.8 (107d). In addition, for the items 106b and 106c of no interest to the user, among the items 106a, 106b, 106c, and 106d selected by teacher #1 120, arbitrary low score values δ 108a and 108b, instead of the post-use preference values predicted by the teacher #2 130, may be used as the soft labels. This is because it is determined that the teacher #1 120 is unlikely to be used even when the teacher #1 120 is recommended to a target user based on the results of prediction of items 106b and 106c, which is of no interest to the user.

The student model 110 may perform learning by receiving from teacher #2 130, as the soft labels, the post-use preference values 107a and 107d respectively for the items 106a and 106d of interest to the user among the items 106a, 106b, 106c, and 106d selected by the teacher #1 120, and the arbitrary low score values δ 108a and 108b respectively for the items 106b and 106c of no interest to the user, among the items 106a, 106b, 106c, and 106d selected by the teacher #1 120.

In the case of the items 106a and 106d of interest, which are transferred by the teacher #1 120, the student model 110 may perform learning to accurately predict the evaluation scores 107a and 107d, which the user may assign to post-use items. In addition, the student model 110 may perform learning so that the items of no interest are not recommended to the user, by predicting the post-use preference as low by using the arbitrary low score values δ 108a and 108b respectively for the items 106b and 106c of no interest, which have been transferred from the teacher #1 120.

In an embodiment, the student model 110 may perform learning by using distilled knowledge obtained by collaboration of the teacher #1 120 and the teacher #2 130, and by using the distilled knowledge, may recommend items having high pre-use preference and high post-use preference to the target user. The distilled knowledge obtained by collaboration of the teacher #1 120 and the teacher #2 130 may determine, as the soft labels, the preset arbitrary low score values δ 108a and 108b, while disregarding the post-use preference values 107a and 107d respectively for the items 106a and 106d of interest to the user among the items 106a, 106b, 106c, and 106d recommended by the teacher #1 120, and the post-use preference values of about 1.3 (107b) and about 2.1 (107c), which the teacher #2 130 has already respectively predicted for the items 106b and 106c of no interest to the user among the items 106a, 106b, 106c, and 106d recommended by the teacher #1 120.

FIG. 2 is a diagram illustrating an example of pre-use preference and post-use preference for items, according to an embodiment.

Explicit feedback may represent two types of user preference for an item, that is, the pre-use preference and the post-use preference. The pre-use preference may be referred to as a user's feeling about an item, which may be obtained by the user from an external characteristic of the item before actually using the item. The item evaluated by the user in a user item evaluation matrix may be referred to as having high pre-use preference of the user. As illustrated in FIG. 2, the user may have high pre-use preference for an item #1 and an item #2 evaluated by the user. Normally, P may represent the pre-use preference matrix 102.

$${p}_{u , i} = \{ \begin{matrix}1 & if user u interacted with item i ; \\ ∅ & otherwise .\end{matrix} \qquad Equation 2$$

To this end, a CF model may be used to predict a user's pre-use preference for a missing item (an unobserved item), such as item #3 in FIG. 2.

Post-use preference may be referred to as an explicit evaluation of an item after the user actually uses the item. In the user item evaluation matrix R 101, the post-use preference value may be obtained from a rating score (for example, on a scale of 1 to 5), which is originally assigned by the user to the item. It may be inferred that, in FIG. 2, the user has high post-use preference for the item #1 evaluated as ‘5’ by the user, and a low post-use preference for the item #2 evaluated as ‘1’ by the user. Accordingly, the post-use preference matrix Q 103 may be defined as in Equation 3.

$${q}_{u , i} = \{ \begin{matrix}{r}_{u , i} & if user u interacted with item i ; \\ ∅ & otherwise .\end{matrix} \qquad Equation 3$$

To this end, a CF model may be used to predict a user's post-use preference for a missing item (an unobserved item), such as item #3 in FIG. 2.

Referring to FIG. 1, the recommendation system 100 may provide a framework for the explicit feedback. The recommendation system 100 may train a plurality of teacher models (for example, the teacher #1 120 and the teacher #2 130) by using pre-use preference and post-use preference of the user for each item. The recommendation system 100 may select an item to be transferred to the student model 110, based on the pre-use preference predicted by the teacher #1 120.

The recommendation system 100 may determine the soft label of the item selected by the teacher #1 120 based on the post-use preference predicted by the teacher #2 130, and may recommend an item by using the student model 110 having learned by using twice-distilled knowledge obtained by collaboration of two teacher models. In an embodiment, it will be described as an example that a recommendation model includes the two teacher models and one student model 110.

The recommendation system 100 may utilize twice-distilled knowledge obtained by using the two teacher models, which have learned by using pre-use preference and post-use preference.

The teacher #1 120 may be trained by using pre-use preference of the user for the item. In the user item rating matrix R 101, it may be inferred that the user has high pre-use preference for an evaluated item (observed item). Without high pre-use preference, items evaluated from the beginning by the user (that is, observed items) would not have been wasted. Accordingly, the pre-use preference matrix P 102 may be interpreted as a single-class setting. The pre-use preference for an observed item 104 may be ‘1’ (that is, highest), and the pre-use preference for the unobserved item 105 may be ambiguous.

To train the teacher #1 120, all CF models of the single-class setting (for example, weighted regularized matrix factorization (WRMF), Bayesian personalized ranking (BPR), or the like) may be adopted. Firstly, in the pre-use preference matrix P 102, the item observed by the user may be regarded as ‘1’ and the item unobserved by the user may be regarded as ‘empty’. Next, the teacher #1 120 may learn to predict that the pre-use preference of the user for the item ‘1’ will be higher than the item with ‘empty’. The pre-use preference of the user for the unobserved item 105 may be predicted by using the learned teacher #1 120.

In an embodiment, utilization of WRMF, which is one of the CF models most widely adopted in the single-class setting, will be described as an example. WRMF has been demonstrated to show a remarkable recommendation accuracy when used to predict the pre-use preferences of the user for items. When receiving the pre-use preference matrix P 102 as an input, the WRMF may perform initializing the unobserved items to zero, and convert the observed items into a matrix so that the observed items are filled with ‘1’ and the unobserved items are filled with ‘0’.

The teacher #1 120 may learn by decomposing the pre-use preference matrix P 102 into two sub matrices U and V respectively representing potential characteristics of the user and the item, and by predicting the pre-use preference of the user for the item. The loss function for the pre-use preference predicted by the teacher #1 120 may be as follows.

$$ℒ ( U , V ) = {\sum }_{u} {\sum }_{i} {w}_{u , i} \{ {( {p}_{u , i} - {U}_{u} {V}_{i}^{T} )}^{2} + λ ( {‖ {U}_{u ( \cdot )} ‖}_{F}^{2} + {‖ {V}_{i ( \cdot )} ‖}_{F}^{2} ) \} \qquad Equation 4$$

In this case, p_{u,i} may represent the pre-use preference of a user u for an item i. w_{u,i} may represent a weight corresponding to p^{u,i}. Uᵤ and Vᵢ may be vectors representing latent characteristics of the user u and the item i, respectively. ∥(⋅)∥_{F} may represent Frobenius norm, and λ may represent a normalization parameter. By using the learned teacher #1 120, a matrix \hat{P} may be approximated by performing an inner product of U and V, as shown in Equation 5. In this case, \hat{p}_{u,i} may represent the pre-use preference of the user u predicted for the item i.

\hat{P}=UV^{T} Equation 5:

The teacher #2 130 may learn by using the post-use preference of the user for the item, and in this case, the post-use preference may be inferred by using the rating score (for example, on a scale of 1 to 5) assigned to the item by the user after using the post-use preference. In other words, initially, the post-use preference matrix Q 103 may be the same as the user item evaluation matrix R 101 in the explicit feedback setting. With respect to the observed item 104, the teacher #2 130 may learn to minimize an error between the evaluation assigned by the user and a label predicted by the model. As a result, the post-use preference for the unobserved item 105 of the user may be obtained by using a score predicted by the learned teacher #2 130. In an embodiment, an adoption of a collaborative denoising auto-encoder (CDAE) and neural matrix factorization (NeuMF) to the teacher #2 130 will be described as an example. To train the teacher #2 130, the CDAE and NeuMF may be optimized by using cross entropy losses as follows.

$${ℒ}_{CE} = - {\sum }_{( u , i )} ( \frac{{q}_{u , i}}{max ( R )} log ( {\hat{q}}_{u , i} ) + ( 1 - \frac{{q}_{u , i}}{max ( R )} ) log ( 1 - {\hat{q}}_{u , i} ) ) \qquad Equation 6$$

In this case, q_{u,i} may represent the post-use preference of the user u for the item i. For example, \hat{q}_{u,i} may represent the original rating score stored in the items observed in the post-use preference matrix Q 103.

max(R) may represent the maximum score of the evaluation scale adopted by the matrix R for normalization. In the embodiment of FIG. 2, the max(R) may correspond to a score of 5. \hat{q}_{u,i} may represent the post-use preference of the user u for the item i predicted by the teacher #2 130 having learned the post-use preference matrix Q 103.

To infer \hat{q}_{u,i}, the CDAE may adopt the teacher #2 130, and reconstruct an evaluation vector of the user u (that is, a u^{th} row vector of the matrix Q) by using hidden layers as follows.

\hat{q}_{u,i}=ƒ(Wᵤ^{T}zᵤ+hᵢ) Equation 7:

In this case, ƒ(⋅) may represent a mapping function (that is, an equivalent function or a Sigmoid function). Wᵢ may represent an i^{th} column vector (that is, a weight for the item i) in a weight matrix W, bᵢ may represent an i^{th} element of an offset vector of an output layer, and zᵤ may represent latent representation, for the user u, which has been mapped by using a hidden layer. By using the learned CDAE, the post-use preference of the user u predicted for the item i may be obtained, by finding an i^{th} element of a reconstructed evaluation vector of the user u. The NeuMF adopted by the teacher #2 130 may predict the post-use preference of the user for unobserved items by using a deep neural network having the following equation.

$${ϕ}^{GMF} = {U}_{u}^{G} ⊙ {V}_{i}^{G} , \qquad Equation 8$$

$${ϕ}^{MLP} - {a}_{N} ( {W}_{N}^{T} ( {a}_{N - 1} ( … {a}_{2} ( {W}_{2}^{T} [ \begin{matrix}{U}_{u}^{M} \\ {V}_{i}^{M}\end{matrix} ] + {b}_{2} ) … ) ) + {b}_{N}$$

$${\hat{q}}_{u , i} = σ ( {h}^{T} [ \begin{matrix}{ϕ}^{GMF} \\ {ϕ}^{MLP}\end{matrix} ] ) \qquad Equation 9$$

In this case, ⊙ may represent a vector product for each element. Uᵤ^{G} and Uᵤ^{M} may represent the latent characteristics of a user u for a generalization matrix factorization (GMF) module and a multi-layer perceptron (MLP) module, respectively. Similarly, Vᵢ^{G} and Vᵢ^{M} may represent latent characteristics of an item i, respectively. Wₙ, bₙ, aₙ, and h may represent a perceptron, a weight matrix for an edge weight of the output layer, a bias vector, and an activation function of an n^{th} layer, respectively. By using the learned NeuMF, and supplying a latent vector connected to u and i to the output layer, the post-use preference of the user u predicted for the item may be obtained.

The teacher #1 120 may select an item. After the teacher #1 120 learns (or is trained), an item likely to be used by the user among all of unobserved items 105 may be identified as an item of interest. Alternatively, after the teacher #1 120 learns, an item less likely to be used by the user among all of unobserved items 105 may be identified as an item of no interest.

An item of interest may be likely used when recommended to the user, but may have not been used yet because the user is not aware of the existence of the corresponding item. On the other hand, although the user may be already aware of the existence of the item of no interest, the possibility may be high that the user does not use the item of no interest even because the user does not like the external characteristics of the corresponding item. Accordingly, based on the predicted pre-use preference, an item belonging to a lower θ^{mn}% will be regarded as an item of no interest.

The teacher #1 120 may select an item of interest and an item of no interest of each user, and deliver them to the student model 110. The student model 110 may learn knowledge on the pre-use preference of the unobserved item 105 by using item information (the item of interest and the item of no interest) selected by the teacher #1 120.

It is assumed that an item predicted to have high post-use preference tends to have high pre-use preference. In this situation, advantageous items to the user may be recommended without any problem by using only the knowledge distillation method in the related art, which considers only the post-use preference. To determine whether there is such a tendency, firstly, a top ten item set of the user based on predicted pre-use preference that is, [symbol] ), and another different top ten item set of the user based on predicted post-use preference (that is, ß) may be identified as Yelp, which is an actual data set. Next, a matching rate (that is, | [symbol] ∩ß|/10) between the items of [symbol] and ß may be computed.

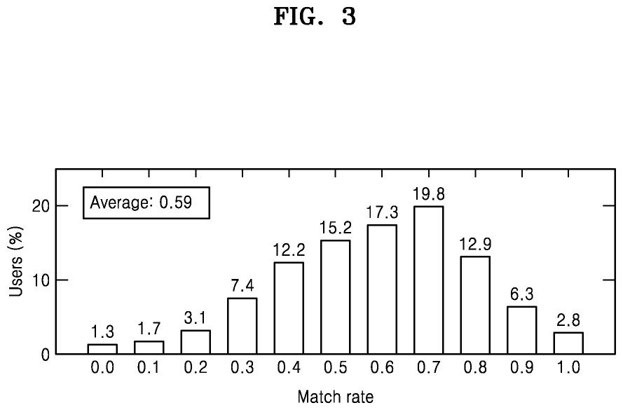

FIG. 3 is a diagram illustrating a matching rate between a set of top ten items based on predicted pre-use preference and a set of top ten items based on predicted post-use preference. In this case, the x-axis may represent a matching rate from about 0.1 to about 1.0, and the y-axis may represent a percentage of a corresponding user. About 40% of the users may show a low matching rate of about 0.5 or less, and an average matching rate of all users may be about 0.59. This fact may indicate that the two preferences appear quite different from each other among users. It may be identified that the user's high (or low) post-use preference for the item does not necessarily indicate high (or low) pre-use preference,

The soft label may be determined by the teacher #2 130. Because the teacher #2 130 has learned according to the post-use preference, item evaluation to be assigned by the user after the user uses the item may be accurately predicted. To this end, the soft labels for the item of interest and the item of no interest, which are transferred to the student model 110, may be determined as follows. The post-use preference predicted by the teacher #2 130 for the item of interest and a particular low rating score δ for the item of no interest may be assigned. In this case, 1 or 2 may be used as a value of δ.

Finally, knowledge jointly distilled by the two teacher models may be summarized as follows. In this case, s_{u,i} may represent the soft label of the user u for the item i, and \hat{q}_{u,i} may represent the post-use preference of the user u predicted by the teacher #2 130 for the item i.

$${s}_{u , i} = \{ \begin{matrix}{\hat{q}}_{u , i} & if i is u ’ s interesting item and {r}_{u , i} = ∅ ; \\ ∅ & otherwise .\end{matrix} \qquad Equation 10$$

TABLE 1

| | |
|---|---|
| Observed items | Preferred items |

| | P@50 | P@100 | P@50 | P@100 |
|---|---|---|---|---|
| Trained teacher #1 | 0.117 | 0.082 | 0.080 | 0.054 |
| Trained teacher #2 | 0.107 | 0.077 | 0.081 | 0.055 |
| Gain (%) | 9.5 | 6.9 | 1.2 | 2.2 |

Table I may present the observed item ratios (that is, precision@N, P@N) among N items higher than a preset order (top) by using an actual data set, or MovieLens 1M (ML1M), and a ratio of the preferred items over the top N items of the learned teacher #1 120 and the teacher #2 130. In this case, the observed item may represent an item used by the user, and the preferred item may represent an item, to which the user has assigned a high evaluation score of 4 or 5 after use. Regardless of N, the teacher #1 120 may identify the observed item better than the teacher #2 130 (that is, may better distinguish between items with high or low pre-use preference of the user). On the other hand, the teacher #2 130 may find the preferred item of the user better than the teacher #1 120 (that is, may better distinguish the item with higher or lower post-use preference of the user). It would be understood that the knowledge jointly distilled by the two teacher models may effectively reveal pre-use preference and post-use preference of a user in the explicit feedback due to a synergy effect obtained by integration of the two teacher models.

After the two teacher models (teacher #1 120 and teacher #2 130), the student model 110 may learn by using a soft label or item ∈S and a hard label or item e R. The student model 110 may use the same CF model as the teacher #2 130, but the size of the same CF model may be small. When CDAE is adopted as the student model 110, the size of the hidden layer may be equal to about 1/10 of the teacher #2 130, and when the NeuMF is used, the size of all layers may be equal to about 1/10 of the teacher #2 130. Accordingly, the loss function used to train the student model 110 by using the hard label (that is, [symbol] _{CF}) may be the same as the loss function of the teacher #2 130 (Equation 6). The soft label of the item transferred by the two learned teacher models may show predicted pre-use preference and post-use preference together. Thus, the loss function to be used to train the student model 110 by using the soft label (that is, [symbol] _{KD}) may be expressed as follows.

[symbol]

_{KD}=β [symbol] ᵢₙ+(1−β) [symbol] ᵤₙ Equation 11:

In this case, [symbol] ᵢₙ and [symbol] ᵤₙ may represent a cross entropy loss function for an item of interest and an item of no interest to the user, respectively. β may represent a balance parameter adjusting weights for loss between an item of interest or an item of no interest while the student model 110 is learned. By adjusting β, it may be prevented that the student model 110 is excessively biased toward the items of no interest due to a large difference between the item of no interest and the item of interest during learning. Thereafter, a framework proposed in the embodiment according to the loss function in Equation 1 may be learned. Lastly, the learned student model 110 may recommend the top N items most favorable to each user with a shorter standby time than the teacher model, while showing higher recommendation accuracy than a small model without knowledge distillation.

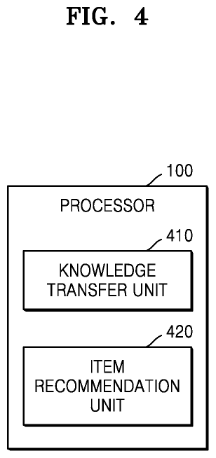

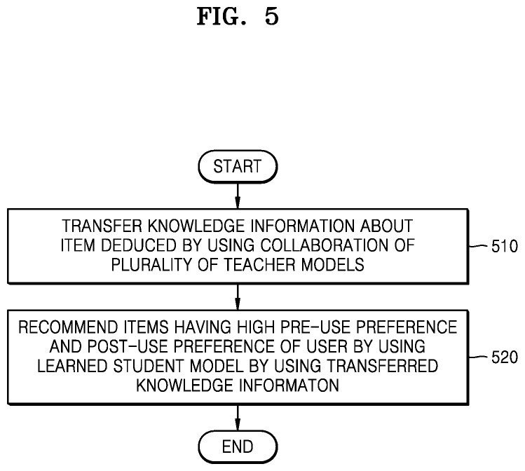

FIG. 4 is a block diagram of a configuration of a recommendation system, according to an embodiment, and FIG. 5 is a flowchart of a recommendation method in a multiple-class CF environment in a recommendation system, according to an embodiment.

A processor of a recommendation system 100 may include a knowledge transfer unit 410 and an item recommendation unit 420. Components of the processor may be a representation of different functions performed by the processor according to a control command provided by program code stored in the recommendation system. The processor and the components thereof may control the recommendation system to perform operations 510 and 520 included in the recommendation method in the multiple-class CF environment in FIG. 5. In this case, the processor and the components thereof may be implemented to execute an instruction according to code of an operating system included in a memory, and an instruction according to code of at least one program.

The processor may load, into a memory, the program code stored in a file of the program for the recommendation method in a multiple-class CF environment. For example, when a program is executed in the recommendation system, the processor may control the recommendation system to load the program code from the file of the program into the memory according to the control of the operating system. In this case, each of the knowledge transfer unit 410 and the item recommendation unit 420 may be a different functional expression of at least one processor for executing subsequent operations 510 and 520 by executing a command of a corresponding portion among the program code loaded in the memory.

The knowledge transfer unit 410 may transfer, to the student model 110, knowledge information about an item deduced by collaboration of a plurality of teacher models (510). The knowledge transfer unit 410 may include the teacher #1 120 and the teacher #2 130. The knowledge transfer unit 410 may transfer, to the student model 110, an item having high pre-use preference and an item having low pre-use preference predicted by any one of the plurality of teacher models included in the recommendation model, among items unobserved by the user. The knowledge transfer unit 410 may transfer, to the student model 110, post-use preference for an item having high pre-use preference and an item having high pre-use preference and an item having low pre-use preference, which are selected by any one teacher model included in the recommendation model and predicted by another teacher model included in the recommended model. The knowledge transfer unit 410 may determine the soft label for an item having high pre-use preference selected by any one teacher model according to post-use preference predicted by another teacher model, and may determine a rating score equal to or less than a preset reference for an item having low pre-use preference selected by any one teacher model. Referring to FIG. 1, the knowledge transfer unit 410 may transfer, to the student model 110, the post-use preference values 107a and 107d predicted by the teacher #2 130 for the items 106a and 106d of interest to the user among the items 106a, 106b, 106c, and 106d selected by the teacher #1 120, and arbitrary low score values δ 108a and 108b assigned to the items 106b and 106c of no interest to the user among the items 106a, 106b, 106c, and 106d selected by the teacher #1 120.

The item recommendation unit 420 may recommend an item having high pre-use preference and high post-use preference of a user by using the student model 110 learned by using the transferred knowledge information (520). The item recommendation unit 420 may recommend an item equal to or greater than a preset reference for each user by using the learned student model 110.

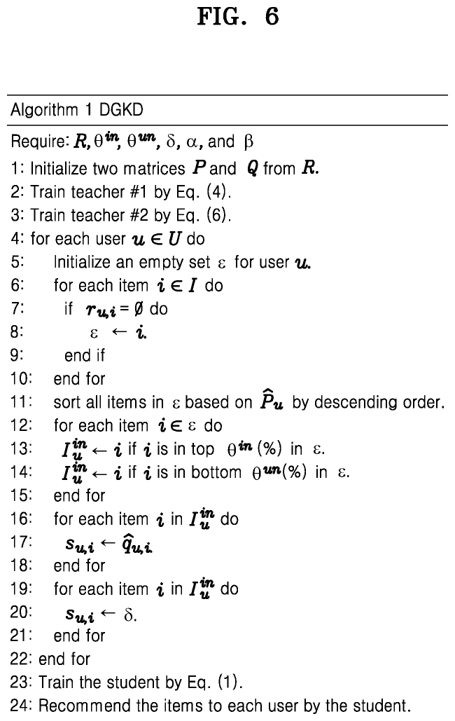

FIG. 6 is a diagram illustrating an example of a knowledge distillation-based recommendation algorithm, according to an embodiment.

When the evaluation matrix R is given in the explicit feedback setting, pseudo code of the knowledge distillation-based recommendation framework according to an embodiment will be described.

Firstly, the teacher #1 120 and the teacher #2 130 may learn by using P and Q matrices, respectively (lines 1-3). Next, both items of interest and items of no interest (that is, [symbol] ᵤⁱⁿ and [symbol] ᵤ^{un}, respectively) may be searched for among unobserved items ∈^{ε} of each user u∈ [symbol] (lines 5-15). In this case, \hat{P}ᵤ may represent a u^{th} row of the matrix \hat{P} [symbol] predicted by the learned teacher #1 120. Thereafter, the soft label for each item of [symbol] ᵤⁱⁿ may be determined according to the post-use preference predicted by the learned teacher #2 130, and may be determined as a particular low rating score δ for each item of [symbol] ᵤ^{un} (lines 16-21). Lastly, the student model 110 may be trained by using the knowledge distilled by the teacher #1 120 and teacher #2 130, and the learned student model may recommend top N items for each user (lines 23-24).

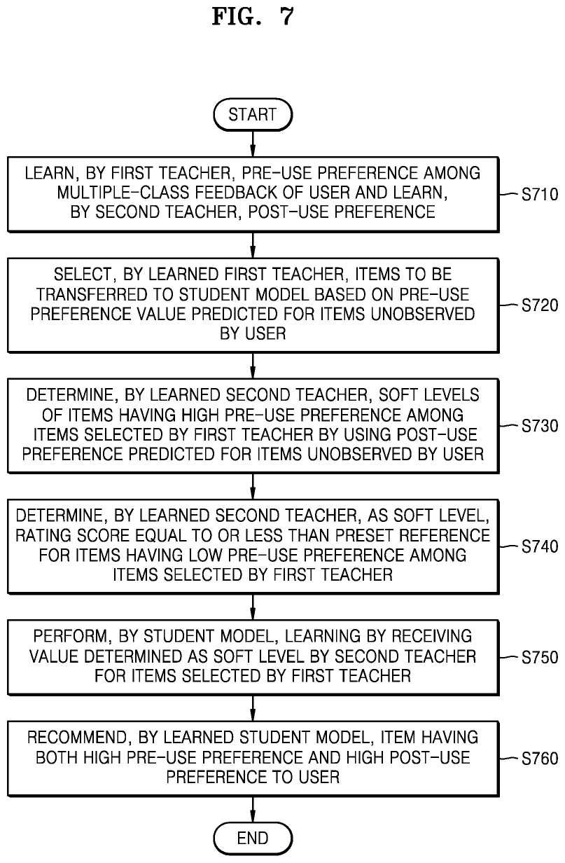

FIG. 7 is a flowchart illustrating an example of a recommendation method in a multiple-class CF environment performed by a recommendation system, according to another preferred embodiment.

Referring to FIG. 1, the recommendation system 100 may use a recommendation model. The recommendation system 100 may perform the recommendation method by using the processor, and in this case, the processor may include a knowledge distillation technique framework using the recommendation model. The recommended model may include two teacher models 120 and 130, and the student model 110. The two teacher models 120 and 130 may constitute the knowledge transfer unit (410 in FIG. 4). The teacher #1 120 may learn pre-use preference in the multiple-class feedback 101, and the teacher #2 130 may learn post-use preference in the multiple-class feedback 101 (S710).

The teacher #1 120 may select the items 106a, 106b, 106c, and 106d to be transferred to the student model 110, based on pre-use preference values predicted for the unobserved items 105, which have never been evaluated by the user. In this case, the teacher #1 120 may select the items 106a, 106b, 106c, and 106d to be transferred to the student model 110 by using a preset ratio θⁱⁿ to be determined as an item of interest and a preset ratio θ^{un} to be determined as an item of no interest (S720).

The items of interest may indicate items having high pre-use preference within θⁱⁿ, and the items of no interest may indicate items having low pre-use preference within θ^{un}.

The teacher #2 130 may determine, as the soft label, the post-use preference values 107a and 107d predicted by the teacher #2 130 for the items 106a and 106d having high pre-use preference among the items 106a, 106b, 106c, and 106d selected by the teacher #1 120 (S730). In addition, the teacher #2 130 may determine, as the soft label, the rating scores 6 (108a, 108b) equal to or less than a preset reference instead of the post-use preference values 107a and 107d predicted by the teacher #2 130 for the items 106a and 106d having low pre-use preference among the items 106a, 106b, 106c, and 106d selected by the teacher #1 120 (S740). In an embodiment, operations S730 and S740, in which the soft labels are respectively determined for the items 106a and 106d having high pre-use preference and the items 106b and 106c having low pre-use preference among the items 106a, 106b, 106c, and 106d selected by the teacher #1 120, may be simultaneously performed.

The student model 110 may receive distilled knowledge deduced by using collaboration of the teacher #1 120 and the teacher #2 130 as knowledge information, and perform learning (S750). In addition, the student model 110 having performed learning may recommend an item having both high pre-use preference and high post-use preference to the user (S760).

The device described above may be implemented as a hardware component, a software component, and/or a combination of a hardware component and a software component. For example, the devices and components described above in the embodiments may be implemented by using, for example, a processor, a controller, an arithmetic logic unit (ALU), a digital signal processor, a microcomputer, a field programmable gate array (FPGA), a microprocessor, or one or more general purpose computers or special purpose computers, such as a certain device capable of executing instructions and responding thereto. A processing device may include an operating system OS, and perform one or more software applications performed on the OS. In addition, the processing device may also, in response to execution of the software, access, store, manipulate, process, and generate data. For convenience of understanding, although the processing device has been described for the case in which one processing device has been used, one of ordinary skill in the art would understand that the processing device may include a plurality of processing elements and/or multiple types of processing elements. For example, the processing device may include a plurality of processors or one processor and one controller. In addition, other processing configurations, such as a parallel processor, may also be feasible.

The software may include a computer program, code, an instruction, or a combination thereof, and may configure the processing device to operate as desired, or command the processing device independently or collectively. Software and/or data may, to be interpreted by a processing device or provide instructions or data to the processing device, be embodied in any type of machine, a component, a physical device, virtual equipment, a computer storage medium, or a computer device. Software may be distributed over a networked computer system, and may also be stored or executed in a distributed manner. Software and data may be stored in one or more computer-readable recording media.

The method according to the embodiment may be implemented in a form of program instructions executable by using various computer means, and may be recorded in a computer-readable medium. The computer-readable medium may include program instructions, data files, data structures, or the like, separately or in a combination thereof. The program instructions to be recorded on the medium may be those particularly designed and configured for the embodiments, or may also be available to one of ordinary skill in the art of computer software. Examples of the computer-readable recording media may include magnetic media, such as a hard disk, a floppy disk and magnetic tape, optical media, such as compact disk (CD)-read-only memory (ROM) (CD-ROM) and a digital versatile disk (DVD), magneto-optical media, such as a floptical disk, and hardware devices particularly configured to store and perform program instructions, such as ROM, random access memory (RAM), and a flash memory. Examples of program instructions may include machine language code, such as those generated by a compiler, as well as high-label language code, which is executable by a computer using an interpreter, etc.

By using a student model having learned both pre-use preference and post-use preference for an item based on distilled knowledge obtained by using collaboration of a plurality of teacher models, an item may be recommended at a fast speed, and at the same time, an item recommendation accuracy may also be improved.

Although the embodiments have been described with reference to limited embodiments and the drawings, one of ordinary skill in the art may apply various modifications and variations on the descriptions above. For example, an appropriate result may be obtained even when the described techniques are performed in a different order from the described method, and/or components, such as a system, a structure, devices, and circuits are connected or combined in a different type from the described manner, or substituted or replaced with other components or equivalent material.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims and their equivalents.

What is claimed is:

1. A recommendation method, performed by a recommendation system including at least one processor in a multiple-class collaborative filtering environment, the recommendation method comprising:
transferring to a student model, by a knowledge transfer unit implemented by at the at least one processor, knowledge information about an item deduced by using collaboration of a plurality of teacher models; and
recommending, by an item recommendation unit implemented by the at least one processor, an item having a high pre-use preference and a high post-use preference of a user by using the student model, which has performed learning by using the transferred knowledge information, wherein a recommendation model used by the recommendation system comprises the plurality of teacher models and the student model and is configured to recommend the item based on a knowledge distillation technique.

2. The recommendation method of claim 1, wherein the transferring comprises transferring, to the student model, an item having a high pre-use preference and an item a having low pre-use preference, predicted by a teacher model among the plurality of teacher models included in the recommendation model, among items unobserved by the user.

3. The recommendation method of claim 1, wherein a first teacher model among the plurality of teacher models has learned a pre-use preference of the user for an item.

4. The recommendation method of claim 1, wherein a second teacher model among the plurality of teacher models has learned a post-use preference of the user for an item.

5. The recommendation method of claim 1, wherein a first teacher model, among the plurality of teacher models, is configured to select a first item based on a high pre-use preference predicted by the first teacher model and a second item based on a low pre-use preference predicted by the first teacher model,
wherein the transferring comprises transferring, to the student model, a post-use preference predicted by a second teacher model for the first item, and a post-use preference predicted by the second teacher model for the second item.

6. The recommendation method of claim 5, wherein the transferring comprises determining a soft label for the first item as a post-use preference predicted by the second teacher model, and determining a soft label for the second item as a rating score equal to or less than a preset reference.

7. A recommendation method, performed by a recommendation system including a knowledge transfer unit and item recommendation unit, implemented by at least one processor, in a multiple-class collaborative filtering environment, the knowledge transfer unit including a first teacher and a second teacher, the recommendation method comprising:
learning, by the first teacher, a pre-use preference among pieces of multiple-class feedback received from a user, and learning, by the second teacher, a post-use preference among the pieces of multiple-class feedback;
predicting, by the first teacher, a pre-use preference for items unobserved by the user based on the learned pre-use preference, and selecting items to be transferred to a student model based on the predicted pre-use preference;
determining, by the second teacher, a soft label based on a post-use preference, which is predicted for items selected by the first teacher based on the learned post-use preference, and transferring the determined soft label as distilled knowledge to the student model; and
performing, by the student model, learning based on the received distilled knowledge, and recommending items having a high pre-use preference and a high post-use preference by using the item recommendation unit.

8. The recommendation method of claim 7, wherein the knowledge transfer unit is configured to train the first teacher by generating a pre-use preference matrix based on items having a record of being evaluated by the user, and train the second teacher by generating a post-use preference matrix based on a rating score actually evaluated by the user for the items having the record of being evaluated by the user.

9. The recommendation method of claim 7, wherein the student model is configured to receive the distilled knowledge that is distilled twice by using collaboration of the first teacher and the second teacher.

10. The recommendation method of claim 7, wherein the knowledge transfer unit is configured to:
use, as the soft label, the post-use preference predicted by the second teacher only for an item having a high pre-use preference among the items, selected by the first teacher among the items unobserved by the user, and
determine a rating score equal to or less than a preset reference for an item having a low pre-use preference among the items selected by the first teacher as the soft label, and transfers the soft label to the student model as the distilled knowledge.

11. A non-transitory computer-readable medium storing program executable by at least one processor to perform the recommendation method of claim 1.

12. A recommendation system comprising at least one processor to implement:
a knowledge transfer unit configured to transfer, to a student model, knowledge information related with an item deduced by using collaboration of a plurality of teacher models; and
an item recommendation unit configured to recommend an item having a high pre-use preference and a high post-use preference of a user by using the student model having learned by using the transferred knowledge information,
wherein a recommendation model comprises the plurality of teacher models and the student model and is configured to recommend an item based on a knowledge distillation technique.

13. The recommendation system of claim 12, wherein
the knowledge transfer unit is further configured to transfer, to the student model, an item having a high pre-use preference and an item having a low pre-use preference predicted by a teacher model among the plurality of teacher models included in the recommendation model among items unevaluated by the user, and
the teacher model has learned a pre-use preference of the user for the item.

14. The recommendation system of claim 12, wherein
a first teacher model is configured to select a first item based on a high pre-use preference predicted by the first teacher model and a second item based on a low pre-use preference predicted by the first teacher model, and
the knowledge transfer unit is further configured to transfer, to the student model, a post-use preference for the first item, predicted by a second teacher model, and a post-use preference for the second item, predicted by the second teacher model.

15. The recommendation system of claim 12, wherein the item recommendation unit is further configured to learn, by using the student model, a pre-use preference and a post-use preference for the item transferred as the knowledge information by using the collaboration of the plurality of teacher models, and recommend an item equal to or greater than a preset reference for each user by using the learned student model.
